(19) United States
(12) Patent Application Publication
(10) Pub. No.: US 2006/0108566 A1
(43) Pub. Date: May 25, 2006

(54) Conductive composition exhibiting PTC behavior and over-current protection device using the same

(76) Inventors: Yun Ching Ma, Pingtung City (TW); Tong Cheng Tsai, Tainan City (TW); Kuo Hsun Chen, Miaoli County (TW)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/266,217

(22) Filed: Nov. 4, 2005

Related U.S. Application Data
(60) Provisional application No. 60/629,487, filed on Nov. 19, 2004.

(51) Int. Cl. H01B 1/12

(52) U.S. Cl. 252/500

(57) ABSTRACT

The present invention discloses a conductive composition comprising a plurality of polymers and at least one conductive filler. The polymers are compatible under a molecular size and the form of the conductive filler includes a flake. The conductive composition of the present invention owns better electrical characteristics than a conventional conductive composition that comprises a single polymer. The present invention further discloses an over-current protection device comprising two metal foils and a PTC (positive temperature coefficient; PTC) composition layer. The PTC composition layer contains the conductive composition.

### BACKGROUND OF THE INVENTION

1. Field of the Invention

The present invention relates to a conductive composition exhibiting Positive Temperature Coefficient (PTC) behavior, and more particularly, to a conductive composition exhibiting PTC behavior that can be applied to an over-current protection device. The present invention also relates to an over-current protection device that contains the conductive composition exhibiting PTC behavior.

2. Description of the Prior Art

A conductive composition exhibiting PTC behavior acts as a current-sensitive element due to its sensitivity to temperature. Therefore, the PTC conductive composition has been widely applied to the over-current protection device for protecting batteries or circuit elements. The resistance of the PTC conductive composition is very low at room temperature so that the circuit elements or the batteries can operate normally. However, if an over-current or an over-temperature situation occurs, the resistance of the PTC conductive composition will immediately increase at least ten thousand times (over 10⁴ ohm) to a high resistance state. Therefore, the over-current will be counterchecked and the objective of protecting the circuit elements or batteries is achieved.

Generally, the PTC conductive composition is composed of at least one crystalline polymer and a conductive filler well dispersed in the polymer. The polymer is a polyolefin such as polyethylene. The conductive filler is carbon black, metal powder or non-oxygen ceramic powder such as titanium carbide (TiC) or tungsten carbide (WC).

The conductivity of the conductive composition depends on the category or content of the conductive filler. Generally, the carbon black has better adhesion with the polyolefin because of its rough surface. Therefore, the PTC conductive composition with carbon black has better resistance reproductivity. On the other hand, the conductivity provided by the carbon black is smaller than that provided by metal powder. The specific gravity of the metal powder is greater than that of carbon black; therefore, the metal powder cannot be dispersed well and is vulnerable to oxidization. To decrease the resistance of the over-current protection device and avoid being oxidized, the conductive filler of the conductive composition tends to use the non-oxygen ceramic powder. Unlike the carbon black, the non-oxygen ceramic powder does not have a rough surface, and the adhesivity of the ceramic powder to the polyolefin is less than that of carbon black. Therefore, the resistance reproductivity of the conductive composition with non-oxygen ceramic powder is difficult to control. To improve the adhesion between the ceramic powder and polyolefin, the conventional conductive composition with the ceramic powder further comprises a coupling agent, such as anhydride or silane. However, the coupling agent cannot effectively decrease the entire resistance of the conductive composition.

When the PTC conductive composition is applied in the over-current protection device, the electrical properties of the PTC conductive composition, such as cycle lifetime, trip endurance and thermal shock, should be considered together with low resistance at room temperature. The above characteristics prove that the PTC conductive composition retains PTC behavior after undergoing repeated over-current or over-temperature situations.

### SUMMARY OF THE INVENTION

The objective of the present invention is to provide a conductive composition with positive temperature coefficient (PTC) behavior by adding two polymers compatible under a molecular size and a conductive filler in the form of a flake to improve the electrical properties, such as cycle lifetime, trip endurance and thermal shock.

In order to achieve the above objective, the present invention discloses a conductive composition exhibiting PTC behavior, which comprises:

(a) a plurality of polymers; and

(b) at least one conductive filler dispersed in the polymers.

The polymers of component (a) are crystalline or non-crystalline polymers, which are selected from the group consisting of epoxy resin, carboxylic resin, high-density polyethylene, polyethylene, polypropylene, polyoctylene and its copolymer or the mixture thereof. In addition, the polymers of component (a) are compatible under a molecular size. In the embodiments, if the mixture of high-density polyethylene and epoxy resin, or the mixture of high-density polyethylene and carboxylic resin is used as the polymers of component (a), the quantity of high-density polyethylene is from 40% to 70% by volume and the quantity of carboxylic resin or epoxy resin is from 5% to 25% by volume.

The conductive fillers of component (b) are carbon black, metal or ceramic powders. In the embodiments, if the mixture of nickel powder and carbon black is used as the conductive filler of component (b), the quantity of nickel powder is from 23% to 33% by volume. In addition, the nickel powder is in the form of a flake, but not a filament. That is, the form of the conductive fillers of component (b) includes a flake.

The PTC composition of the present invention further comprises a coupling agent to improve the resistance uniformity and processibility. The quantity of the above coupling agent is from 0 to 5% by volume.

### BRIEF DESCRIPTION OF THE DRAWINGS

The invention will be described according to the appended drawing in which:

FIG. 1 illustrates the over-current protection device of the present invention.

### DETAILED DESCRIPTION OF THE INVENTION

In order to achieve the above objectives and to avoid the disadvantages of the prior art, the present invention discloses a conductive composition, comprising:
(a) at least two polymers; and
(b) at least two conductive fillers, dispersed in the at least two polymers;

Also, the present invention further comprises a coupling agent to improve the resistance.

The at least two polymers of the component (a) are crystalline or non-crystalline polymers, which are selected from the group consisting of epoxy resin, polyethylene, polypropylene, polyoctylene and its copolymer or the mixture thereof. The volume percentage of the polymers is from approximately 40% through 70%, preferably from approximately 50% through 60%.

In component (b), the materials of the conductive fillers are carbon black, metal or ceramic powder. The conductive fillers are selected from the group consisting of carbon black, nickel, silver, gold, graphite, titanium carbide, tungsten carbide and the mixture thereof and it is in grain, flake, fiber or powder form. The volume percentage of the conductive fillers is from approximately 30% through 60%, preferably from approximately 40% through 50%.

The present invention further comprises the coupling agent that can improve the adhesion between the conductive fillers and the polymers and thus reduce the resistance. The coupling agent is selected from the group consisting of silane and zirconium complex. The volume percentage of the coupling agent is from approximately 0.1% through 7%, preferably from approximately 1% through 5%.

### EXAMPLE

The compositions used in the Examples and the Comparative Examples are shown in Table 1

TABLE 1

| | Commercial Name | |
|---|---|---|
| Component | (Company) | Feature |
| High density | 8010 | melt index: 1.0 g/10 min; |
| polyethylene | (Taiwan Plastics) | specific gravity: 0.96; |
| | | melting point: 130° C. |
| | | (measured by differential |
| | | scanning calorimetry) |
| Epoxy Resin | AX8840 (Atofina) | melt index: 5.0 g/10 min |
| | | specific gravity: 0.94; |
| | | melting point: 106° C. |
| | | (Epoxy: 8% by volume) |
| Carboxylic | MB-100D | specific gravity: 0.9˜0.96; |
| Resin | (Du Pont) | melting point: 130° C. |
| | | (Anhydride: 1% by volume) |
| Nickel Powder | Ni-102 (AEE) | flake form; |
| | | specific gravity: 8.9 |
| | | particle size: 3 μm |
| Carbon Black | Raven430 | aggregated form; |
| | (Columbian | specific gravity: 1.8 |
| | Chemical Co.) | particle size: 82 nm |
| Coupling Agent | Capow 12 | Powder form; |
| | (Kenrich) | specific gravity: 1.3 |
| | | (active ingredient: 50% |
| | | by volume) |

### Example 1 (EX-1)

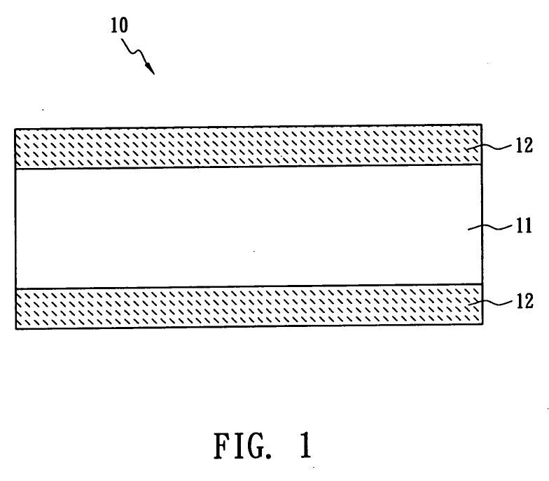

The formula used in Example 1 is shown in Table 2 and the process for forming the over-current protection device 10 (refer to FIG. 1) is described below. The raw material is fed into a blender (Hakke 600) at 160° C. for 2 minutes. The procedure of feeding the raw material is: add a quantity of high-density polyethylene into the blender; after blending for a few seconds, add the conductive fillers (nickel powder and/or carbon black) into the blender. The rotational speed of the blender is set at 40 rpm. After blending for 3 minutes, the rotational speed increases to 70 rpm. After blending for 3 minutes, the mixture in the blender is drained and thereby a conductive composition with positive temperature coefficient (PTC) behavior is formed.

The above conductive composition is loaded into a mold, wherein the top and the bottom of the mold are disposed with a Teflon cloth. The mold is a steel form with an inside thickness of 0.25 mm. First, the mold with the conductive composition is pre-pressed for 3 minutes at 50 kg/cm², 180° C. Then, the gas in the mold is exhausted and the mold is laminated for 3 minutes, at 150 kg/cm², 180° C. The laminating step is repeated once at 150 kg/cm², 180° C. for 3 minutes. After that, a PTC sheet 11 (refer to FIG. 1) is formed. Then, the PTC sheet 11 is cut to become a square of 20×20 cm². Two metal foils 12 are laminated on the top and bottom surfaces of the PTC sheet 11. The PTC sheet 11 is first sandwiched between the top and the bottom metal foils 12, Teflon cloths (not shown), buffer layers (not shown), Teflon cloths and steel plates, respectively, all of which are disposed symmetrically on the top and bottom surfaces of the PTC sheet 11, thereby forming a multi-layered structure. The structure is thereafter laminated for 3 minutes at 70 kg/cm², 180° C. Finally, the PTC sheet 11 is cut to form the over-current protection device 10 with 6.5×3.5 mm², which can be used for subsequent tests. The resistance of the PTC device is measured by a micro-ohmmeter; the measured result is shown in Table 2.

### Example 2 (EX-2)

The process for forming the over-current protection device 10 is the same as Example 1. However, the volume percentage of HDPE decreases from 57% to 44%, and 3% by volume of coupling agent (Capow-12) is added into the conductive composition. The components of the conductive composition and the electrical properties are shown in Table 1-1.

### Example 3 (EX-3)

The process for forming the over-current protection device 10 is the same as Example 1. However, the volume percentage of HDPE decreases from 57% to 47%, and 10% by volume of carboxylic resin is added into the conductive composition. The components of the conductive composition and the electrical properties are shown in Table 1-2.

### Example 4 (EX-4)

The process for forming the over-current protection device 10 is the same as Example 2. However, the volume percentage of HDPE decreases from 54% to 44%, and 10% by volume of carboxylic resin is added into the conductive composition. The components of the conductive composition and the electrical properties are shown in Table 1-2.

### Example 5 (EX-5)

The process for forming the over-current protection device 10 is the same as Example 1. However, the volume percentage of HDPE decreases from 57% to 47%, and 10% by volume of epoxy resin is added into the conductive composition. The components of the conductive composition and the electrical properties are shown in Table 1-2.

### Example 6 (EX-6)

The process for forming the over-current protection device 10 is the same as Example 2. However, the volume percentage of HDPE decreases from 54% to 44%, and 10% by volume of epoxy resin is added into the conductive composition. The components of the conductive composition and the electrical properties are shown in Table 1-2.

### Comparative Example 1 (CE-1)

The process for forming the over-current protection device 10 is the same as Example 1. However, there is no nickel added and the volume percentage of HDPE increases from 57% to 60% and the volume percentage of carbon black increases from 15% to 40%. The components of the conductive composition and the electrical properties are shown in Table 1-1.

### Comparative Example 2 (CE-2)

The process for forming the over-current protection device 10 is the same as Example 1. However, there is no carbon black added and the volume percentage of HDPE increases from 57% to 72%. The components of the conductive composition and the electrical properties are shown in Table 1-1.

### Comparative Example 3 (CE-3)

The process for forming the over-current protection device 10 is the same as Example 2. However, there is no carbon black added and the volume percentage of HDPE increases from 54% to 69%. The components of the conductive composition and the electrical properties are shown in Table 1-1

TABLE 1-1

| | CE-1 | CE-2 | CE-3 | EX-1 | EX-2 |
|---|---|---|---|---|---|
| Components (% by vol.) | | | | | |
| HDPE (8010) | 60 | 72 | 69 | 57 | 54 |
| Epoxy Resins (8840) | | | | | |
| Carboxylic Resins | | | | | |
| (MB-100D) | | | | | |
| Nickel Flake | | 28 | 28 | 28 | 28 |
| (Ni-102) | | | | | |
| Carbon Black | 40 | | | 15 | 15 |
| (Reven430U) | | | | | |
| Coupling Agent | | | 3 | | 3 |
| (Capow-12) | | | | | |
| Electrical Properties | | | | | |
| ρ₀(Ω)⁽¹⁾ | 0.226 | 0.005 | 0.004 | 0.043 | 0.025 |
| ρ₁ₘₐₓ(Ω)⁽²⁾ | 0.255 | 0.011 | 0.016 | 0.077 | 0.069 |

TABLE 1-2

| | EX-3 | EX-4 | EX-5 | EX-6 |
|---|---|---|---|---|
| Components (% by vol.) | | | | |
| HDPE (8010) | 47 | 44 | 47 | 44 |
| Epoxy Resins (8840) | | | 10 | 10 |
| Carboxylic Resins (MB-100D) | 10 | 10 | | |
| Nickel Flake (Ni-102) | 28 | 28 | 28 | 28 |
| Carbon Black (Reven430U) | 15 | 15 | 15 | 15 |
| Coupling Agent (Capow-12) | | 3 | | 3 |
| Electrical Properties | | | | |
| ρ₀(Ω)⁽¹⁾ | 0.442 | 0.099 | 0.651 | 0.042 |
| ρ₁ₘₐₓ(Ω)⁽²⁾ | 1.298 | 0.146 | 1.227 | 0.058 |
| ρ₁ₘₐₓ/ρ₀ | 2.94 | 1.47 | 1.88 | 1.38 |
| Cycle Life⁽³⁾ ρ₄₀₀/ρ₀ | 10.74 | 63.04 | 13.48 | 79.89 |
| Trip Endurance⁽⁴⁾ ρ_{48 hr}/ρ₀ | 12.10 | 39.85 | 8.39 | 54.13 |
| Thermal Shock⁽⁵⁾ ρ₁₀₀/ρ0 | 31.94 | 42.75 | 11.22 | 73.03 |

note:
⁽¹⁾The initial resistance (Ω) of the device measured at room temperature.
⁽²⁾The resistance (Ω) measured after a one-hour trip.
⁽³⁾A cycle life test means the device is tripped under conditions of 6 V/40 A for 10 seconds and then the conditions are removed for 60 seconds. ρ₄₀₀ means the resistance measured after 400 cycles of the cycle life test.
⁽⁴⁾Trip endurance means the device is tripped for 48 hours under conditions of 7.2 V/40 V. ρ_{48 hr} means the resistance measured at 48 hours after the trip endurance test.
⁽⁵⁾A cycle of thermal shock test means the device is treated at a temperature of −40° C. for 30 minutes and then 80° C. for 30 minutes, ρ₁₀₀ means the resistance measured after 100 cycles of the thermal shock test.
⁽⁶⁾The device burns after 168 cycles of the cycle life test.
⁽⁷⁾The device burns after 33 cycles of the cycle life test.

As shown in Table 1-1 and Table 1-2, three comparative examples burn after tripped in the trip endurance test (with a large current). Comparative Examples 1 and 2 both break after 100 cycles of the cycle life test. However, Example 1 to Example 5 still function after the trip endurance test and the thermal shock test.

After comparing Examples 1, 3 and 5, we find that the last two examples have superior performances of cycle life, trip endurance and thermal shock to those of the first example. The reason is that high-density polyethylene and carboxylic resin in Example 3 are compatible under a molecular size; likewise, high-density polyethylene and epoxy resin in Example 5 are compatible under a molecular size.

During Examples 2, 4 and 6, the last two examples with two molecular-size-compatible polymers have superior performances of cycle life, trip endurance and thermal shock to those of the first example.

One end of the molecular structure of carboxylic resin or epoxy resin is a polar functional group that provides good adhesion with nickel powder and carbon black. Another end of the molecular structure of carboxylic resin or epoxy resin is compatible with high-density polyethylene under a molecular size, and that results in superior electrical properties due to better homogeneity.

The methods and features of this invention have been sufficiently described in the above examples and descriptions. It should be understood that any modifications or changes without departing from the spirit of the invention are intended to be covered in the protection scope of the invention.

What is claimed is:

1. A conductive composition exhibiting PTC behavior, comprising:
a plurality of polymers, which are compatible under a molecular size; and
at least one conductive filler dispersed in the polymers, wherein the form of the conductive filler includes a flake.

2. The conductive composition of claim 1, further comprising a coupling agent that improves the resistance uniformity and processibility of the conductive composition.

3. The conductive composition of claim 1, wherein the polymers are selected from the group consisting of epoxy resin, polyethylene, high-density polyethylene, polyoctylene, polypropylene, carboxylic resin and its copolymer or the mixture thereof.

4. The conductive composition of claim 1, wherein the conductive filler is selected from the group consisting of carbon black, metal and ceramic materials.

5. The conductive composition of claim 1, wherein the conductive filler is a mixture of nickel powder and carbon black.

6. The conductive composition of claim 5, wherein the volume percentage of the nickel powder is from 23% to 33%.

7. The conductive composition of claim 5, wherein the volume percentage of the carbon black is from 5% to 25%.

8. The conductive composition of claim 2, wherein the volume percentage of the coupling agent is from 0% to 5%.

9. An over-current protection device, comprising:
two metal foils; and
a PTC composition layer, which comprises:
a plurality of polymers, which are compatible under a molecular size; and
at least one conductive filler dispersed in the polymers, wherein the form of the conductive filler includes a flake.

10. The over-current protection device of claim 9, wherein the polymers are selected from the group consisting of epoxy resin, polyethylene, high-density polyethylene, polyoctylene, polypropylene, carboxylic resin and its copolymer or the mixture thereof.

11. The over-current protection device of claim 9, wherein the conductive filler is selected from the group consisting of carbon black, metal and ceramic materials.

12. The over-current protection device of claim 9, wherein the conductive filler is a mixture of nickel powder and carbon black.
